(19) United States
(12) Patent Application Publication
(10) Pub. No.: US 2011/0232862 A1
(43) Pub. Date: Sep. 29, 2011

(54) FRESH WATER HEATING SYSTEM FOR MOBILE APPLICATIONS

(75) Inventor: Paul Gofton, South Yorkshire (GB)

(73) Assignee: WEBASTO AG, Stockdorf/Gauting (DE)

(21) Appl. No.: 12/756,758

(22) Filed: Apr. 8, 2010

(30) Foreign Application Priority Data
Mar. 29, 2010 (DE) 20 2010 000 488.8

(51) Int. Cl. F25B 29/00; F24H 1/18; G05D 23/13

(52) U.S. Cl. 165/64; 392/441; 236/12.12

(57) ABSTRACT

A fresh water heating system for mobile applications is provided which comprises: a coolant reservoir for storing a predetermined amount of coolant, the coolant reservoir comprising a coolant inlet for supplying coolant to the coolant reservoir and a coolant outlet for discharging coolant from the coolant reservoir; a coolant circuit connected to the coolant inlet and the coolant outlet, the coolant circuit comprising a fuel-operated heat source (5; 5′); and a liquid-to-liquid heat exchanger arranged in the coolant reservoir for transferring heat from stored coolant to fresh water.

The present invention relates to a fresh water heating system for mobile applications.

In the context of the present application, the term “fresh water” is used for water which is intended for direct contact with humans. The fresh water can for example be intended for drinking, for food preparation, for showering, for dish washing, and the like.

In mobile applications as for example in recreational vehicles such as camper vans, in mobile homes, in recreational boats and the like, there is a need to provide fresh water having an elevated temperature for drinking/food preparation, for showering, for dish washing and the like. Conventionally, fresh water is heated in recreational vehicles or boats using electricity from a mains power supply (e.g. when a recreational vehicle is situated at a camp ground where a mains supply is available) or using gas as an energy source. However, under many circumstances a mains power supply is not readily available and thus fresh water cannot be heated in this way. Heating of fresh water using the on-board electricity network is not particularly economically and comes along with a risk of depleting the vehicle battery.

Gas is relatively widely used as an energy source for heating fresh water in mobile applications. However, there are certain drawbacks in using gas. Gas is not always readily available and there is a certain danger of fire or explosion as a result of improper use and/or improper maintenance. Further, e.g. in vehicles comprising a combustion engine, another energy source in form of petrol/gasoline or diesel fuel is already present and the gas has to be stored additionally in a separate storage container which results in additional required storage space.

Thus, it has been proposed to use an auxiliary heating device which is operated with the same fuel as the combustion engine of a motor vehicle for heating fresh water. For example, U.S. 2008/0142609 A1 describes such a system. In the system for heating fresh water described in U.S. 2008/0142609 A1, a fresh water storage reservoir is provided which is adapted to store a predetermined amount of fresh water. In the fresh water storage reservoir, a heat exchanger for transferring heat from a coolant to the fresh water stored in the fresh water storage reservoir is provided. The heat exchanger is formed by a helical piping section which is arranged in the fresh water storage reservoir and through which the coolant is circulated. The coolant is circulated in a closed heat transfer circuit comprising a combustion engine of a motor vehicle and an auxiliary heater. If heated fresh water is needed for a user, the whole amount of fresh water in the fresh water reservoir has to be brought at least to the desired temperature. This results in a relative long heating time. If the fresh water in the fresh water reservoir is maintained in the fresh water reservoir in a heated state such that warm water is immediately available when needed, there is a risk that the fresh is maintained at an elevated temperature over long periods in time. In this case, there is a risk of water quality deterioration which is undesirable from a hygienic point of view. Further, if the described system for heating fresh water was adapted to form a “stand-alone” system which is not integrated into the coolant circuit of a combustion engine, an additional coolant header tank would be required for compensating temperature-induced volume changes of the coolant.

It is an object of the present invention to provide an improved fresh water heating system for mobile applications.

This object is solved by a fresh water heating system for mobile applications comprising: a coolant reservoir for storing a predetermined amount of coolant, the coolant reservoir comprising a coolant inlet for supplying coolant to the coolant reservoir and a coolant outlet for discharging coolant from the coolant reservoir; a coolant circuit connected to the coolant inlet and the coolant outlet; and a liquid-to-liquid heat exchanger arranged in the coolant reservoir for transferring heat from stored coolant to fresh water. The coolant circuit comprises a fuel-operated heat source.

Thus, in the fresh water heating system for mobile applications, coolant which is circulated in the coolant circuit is stored in the coolant reservoir instead of storing fresh water in a fresh water reservoir. In this way, there is no risk of a large amount of fresh water being stored at an elevated temperature for a long period in time. The coolant contained in the coolant reservoir can be efficiently heated using the fuel-operated heat source. The fuel-operated heat source can e.g. be formed by a fuel-operated heating device, by the combustion engine of a vehicle or by a combination of both. Preferably, the fuel-operated heat source is adapted to be operated based on diesel or gasoline. The coolant can be maintained in a heated state over longer periods in time without causing a risk of deteriorating the quality of fresh water to be heated. Hot fresh water can quickly be provided by heating new cold fresh water in the liquid-to-liquid heat exchanger provided in the coolant reservoir. In this way, heated fresh water can be provided very quickly, when the coolant in the coolant reservoir has been heated up before. The heating is achieved by the liquid-to-liquid heat exchanger acting as a flow-type calorifier on the fresh water. Further, the coolant reservoir can also be used as a header tank of the coolant circuit such that an additional separate header tank in the coolant circuit can be dispensed with. Preferably, the coolant circuit is a closed heat transfer circuit.

In the context of this description the term fresh water heating system for mobile applications is used to characterize a fresh water heating system which is adapted such that it is suited for a mobile application. This means that the fresh water heating system is transportable (e.g. incorporated into a vehicle or placed therein for transport purposes) and is not solely adapted for a permanent stationary use as is the case for a fresh water heating system for a stationary building. The fresh water heating system can in particular be adapted for fresh water heating in a vehicle or in temporarily stationary applications such as big tents or mobile cabins (e.g. welfare cabins). Thus, the term fresh water heating system for mobile applications is also used for fresh water heating systems which are adapted for fixed installation in a mobile device (such as a vehicle or a mobile cabin).

According to one realization, an electric heating device for electrically heating the coolant contained in the coolant reservoir is provided. In this case, the coolant in the coolant reservoir can also be heated by means of electric energy, e.g. when a mains power supply is available. Thus, the user can choose which energy source is to be used for heating the coolant stored in the coolant reservoir. The electric heating device can for instance be formed by a resistive heater.

According to one realization, the liquid-to-liquid heat exchanger is formed by a wound pipe section for fresh water to be heated arranged in the coolant reservoir. In this case, the heat is transferred in a particular efficient manner to the fresh water to be heated in the manner of a flow-type calorifier. Thus, new fresh water can be brought to the desired temperature very fast.

According to one realization, a mixer valve is provided which is adapted to automatically mix fresh water heated in the liquid-to-liquid heat exchanger with cold fresh water to provide fresh water having a predetermined temperature. For example, the mixer valve can be arranged connected to the outlet of the liquid-to-liquid heat exchanger and to a fresh water supply. Since the mixer valve is adapted to automatically mix the fresh water heated in the heat exchanger with cold fresh water, the coolant in the coolant reservoir can be brought to high temperatures, e.g. by a fuel-operated heating device or by a combustion engine, and nevertheless fresh water having a desired temperature is provided automatically.

According to one realization, the mixer valve is adapted to automatically provide one of at least two predetermined temperatures of the provided fresh water upon user selection. For example, two predetermined temperatures may be provided for. However, more than two different temperatures are also possible. In this way, water having one predetermined temperature of a plurality of temperatures is provided upon user selection. For example, one temperature which is particularly adapted for preparing hot drinks can be provided and another temperature which is particularly suited for showering or the like can be provided.

According to one realization, the coolant reservoir is adapted as a header reservoir for compensating volume changes in the coolant circuit. In this case, a separate header reservoir in the coolant circuit can be dispensed with. This realization is particularly suited for the coolant circuit being realized as a closed heat transfer circuit. Thus, a particularly inexpensive and compact design is achieved. This can be particularly advantageous in a case where the coolant circuit of the fresh water heating system for mobile applications is not part of an engine coolant circuit of a combustion engine. According to one realization, the coolant circuit is a vehicle engine independent coolant circuit. In this case, the fresh water heating system for mobile applications can be provided as a “stand-alone” system in a very compact manner.

If the fuel-operated heat source is formed by a fuel-operated heating device, the coolant in the coolant reservoir can be heated very efficiently. According to one realization, the fuel-operated heating device is an auxiliary vehicle heater. In this case, an auxiliary vehicle heater which is produced in large quantities relatively inexpensive is also used for providing the heated fresh water. Such an auxiliary vehicle heater is typically constructed for preheating of a combustion engine before the engine is started and to heat the interior of the vehicle. However, some auxiliary vehicle heaters are constructed to be operated only when the combustion engine of the vehicle is running to provide additional heat for the interior of the vehicle. Thus, the fresh water heating system for mobile applications is provided in a cost-efficient manner. In a case where the coolant circuit is a coolant circuit for a combustion engine, in many cases a fuel-operated heating device in form of an auxiliary vehicle heater is already present such that this heater can be additionally used for heating fresh water. Further, the heating power of such auxiliary vehicle heaters is particularly suited for the fresh water heating system for mobile applications.

According to one realization, a combustion engine of a motor vehicle is integrated into the coolant circuit as a fuel-operated heat source. In this case, the waste heat of the combustion engine can also be used for heating the coolant in the coolant reservoir. Further, the fuel-operated heating device can also be used for preheating the combustion engine before it is started. Further, in this case the fresh water heating system for mobile applications can also use a coolant-to-air heat exchanger which is typically present in the coolant cycle of a combustion engine in a vehicle for heating air intended for an internal space of the vehicle, e.g. for a passenger compartment.

According to one realization, the coolant circuit comprises a coolant-to-air heat exchanger for transferring heat from coolant to air for heating an internal space. The internal space can e.g. be formed by an interior of a vehicle such as a passenger compartment. Due to the coolant-to-air heat exchanger, the coolant stored in the coolant reservoir can not only be used for heating fresh water but also for heating the internal space. Thus, the coolant reservoir is used with multi-functionality.

Further developments and advantages will become apparent from the following description of embodiments with reference to the drawing.

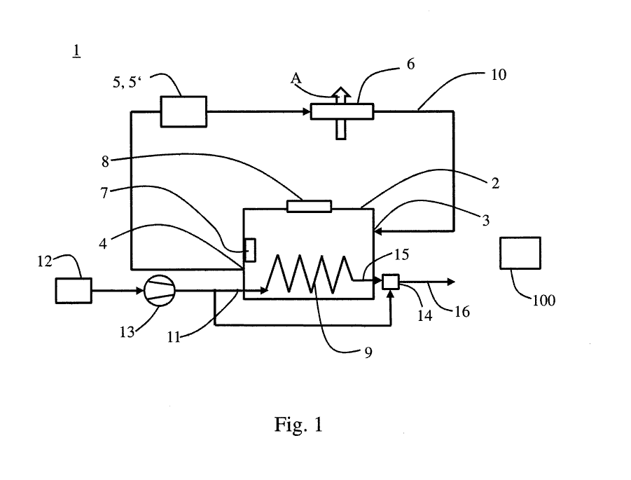

FIG. 1 schematically shows a fresh water heating system for mobile applications.

### FIRST EMBODIMENT

An embodiment will now be described with reference to FIG. 1. The fresh water heating system for mobile applications 1 which will be described in the following with reference to FIG. 1 is formed by a fresh water heating system 1 adapted for being used in a recreational vehicle. The specific fresh water heating system 1 according to the described example is adapted for providing hot fresh water for different purposes such as drink and/or food preparation, showering, dish washing, and the like. Further, in the example which will be described in the following, the fresh water heating system for mobile applications 1 is also adapted for heating an interior of a vehicle, as will become apparent from the description below.

The fresh water heating system 1 comprises a coolant reservoir 2 adapted for storing a predetermined amount of coolant. For example, the coolant reservoir 2 can be adapted to store several liters of coolant, e.g. 5, 7, 10 liters, or the like. The coolant reservoir 2 comprises a coolant inlet 3 for supplying coolant to the coolant reservoir 2 and a coolant outlet 4 for discharging coolant from the coolant reservoir 2. The coolant inlet 3 and the coolant outlet 4 are connected to a coolant circuit 10 through which coolant is circulated. The coolant reservoir 2 is provided with a suitable insulation such that heat losses from the coolant reservoir 2 are minimized. The coolant circuit 10 and the coolant reservoir 2 can e.g. be specifically adapted to be used for coolant comprising a water/glycol mixture (possibly with further additives).

The coolant circuit 10 comprises a fuel-operated heat source which in the present embodiment is formed by a fuel-operated heating device 5. The fuel-operated heating device 5 can be adapted to heat coolant circulated in the coolant circuit by combustion of fuel and air. As an alternative, the fuel-operated heating device 5 can e.g. be adapted such that heat is provided as a result of a catalytic reaction of fuel and air. In the example shown, the fuel-operated heating device 5 is adapted such that it is operated based on diesel or gasoline. In the specific example, the fuel-operated heating device 5 is formed by an auxiliary vehicle heater, i.e. a heater constructed for heating coolant circulated in a coolant circuit of a vehicle combustion engine in order to heat an interior of the vehicle and/or the combustion engine. The fuel-operated heating device 5 comprises a gas-to-liquid heat exchanger for transferring heat from the hot exhaust gases to coolant. Further, the fuel-operated heating device 5 comprises a coolant pump (not shown) for circulating the coolant in the coolant circuit 10. The coolant circuit 10 further comprises a coolant-to-air heat exchanger 6 for transferring some of the heat of the coolant to air (schematically depicted by an arrow A) which is guided to an interior of the vehicle. For example, a blower (not shown) can be provided in conjunction with the coolant-to-air heat exchanger 6. The coolant reservoir 2 is integrated in the coolant circuit 10 such that coolant which is heated by the fuel-operated heating device 5 is fed to the coolant reservoir 2 via the coolant inlet 3 and colder coolant is fed back to the fuel-operated heating device 5 via the coolant outlet 4.

The coolant reservoir 2 is further provided with an electric heating device 7 for electrically heating the coolant contained in the coolant reservoir 2. The electric heating device 7 is adapted to be electrically connectable to a mains supply when such a mains supply is available. The coolant reservoir 2 is constructed such that it compensates pressure differences in the coolant circuit 10 which occur as a result of temperature changes of the coolant. For example, the coolant reservoir 2 can comprise an expansion cap 8 to achieve this. As a consequence, no separate additional header tank is required in the coolant circuit 10 but the coolant reservoir 2 acts as a header tank for the coolant circuit 10 which is constructed as a closed heat transfer circuit.

A liquid-to-liquid heat exchanger 9 is arranged in the coolant reservoir for transferring heat from stored coolant to fresh water. The liquid-to liquid heat exchanger 9 can e.g. be formed by a wound pipe section arranged in the coolant reservoir 2 through which fresh water to be heated is led. The wound pipe section can preferably have a spiral shape. The liquid-to-liquid heat exchanger 9 is adapted to transfer heat from the stored coolant to the fresh water in the manner of a flow-type calorifier. In the liquid-to-liquid heat exchanger 9, heat is transferred from substantially static coolant to flowing fresh water. The liquid-to-liquid heat exchanger 9 is connected to a supply line 11 for supplying (cold) fresh water from a fresh water reservoir 12 to the liquid-to-liquid heat exchanger 9. The fresh water reservoir 12 can for example be formed by a fresh water tank for storing a larger volume of fresh water. However, the fresh water reservoir 12 can e.g. also be formed by another type of fresh water supply which is available, such as a stationary fresh water supply line. In the example shown, a fresh water pump 13 is provided for conveying the fresh water.

The downstream end of the liquid-to-liquid heat exchanger 9 is connected to a mixer valve 14 via a hot water line 15. In the exemplary embodiment, the mixer valve 14 is arranged directly at the coolant reservoir 2 such that a particular compact realization is achieved. The mixer valve 14 is further connected to the supply line 11 for fresh water. The mixer valve 14 is adapted such that fresh water of a desired temperature is output via a warm water output line 16. One or a plurality of users can be connected to the warm water output line 16. For example, a shower cabin can be connected to the warm water output line 16 and/or a tap of a dish washing appliance or the like. The mixer valve 14 is adapted such that fresh water having a predetermined temperature is output. This is achieved by mixing the hot fresh water from the liquid-to-liquid heat exchanger 9 with cold fresh water from the supply line 11.

A control unit 100 for controlling the operation of the fresh water heating system for mobile applications 1 is provided. The control unit 100 is connected to the components of the fresh water heating system 1 via suitable electrical connections (not shown). In particular the fuel-operated heating device 5 and the mixer valve 14 are controlled by the control unit 100. The control unit 100 controls the mixer valve 14 such that automatically a predetermined temperature of the fresh water in the warm water output line 16 is provided. For example, a plurality of discrete temperature values can be predetermined and stored in a memory of the control unit 100. For example, a first temperature value characterizing a typical water temperature for showering can be provided and a second temperature value characterizing a typical water temperature for preparation of hot beverages can be provided. Further temperature values (i.e. more than two) can be provided. If a user selects one of the predetermined temperatures, the mixer valve automatically mixes hot and cold water such that the desired temperature value is provided. To this end, for example temperature sensors (not shown) for sensing the temperature of the hot fresh water coming from the liquid-to-liquid heat exchanger 9 and the temperature of the cold fresh water coming from the supply line 11 can be provided.

Operation of the fresh water heating system 1 will now be described. By operation of the control unit 100, the fuel-operated heating device 5 is operated to heat the coolant in the coolant circuit 10 and the coolant is circulated by operation of the coolant pump associated with the fuel-operated heating device 5. In this way, the temperature of the coolant in the coolant reservoir 2 is raised. The temperature of the coolant in the coolant reservoir 2 can for instance be measured by a suitable temperature sensor (not shown) arranged in the coolant reservoir 2. As a result, the coolant reservoir 2 becomes “loaded” to a high temperature. If the temperature of the coolant in the coolant reservoir 2 reaches a predetermined upper temperature value, operation of the fuel-operated heating device 5 is stopped. If the temperature of the coolant in the coolant reservoir 2 falls below a predetermined lower temperature value, operation of the fuel-operated heating device 5 is started again. This can for instance be realized using a suitable thermostat or a plurality of thermostats in the coolant reservoir 2. The upper temperature value and the lower temperature value can be adjustable by a user. For example, for a hand wash application, i.e. the warm fresh water in the warm water output line 16 is used for hand washing, the upper temperature value can be set to e.g. 80° C. (or to another suitable value) and the lower temperature value can be set to e.g. 40° C. (or to another suitable value). In this way, the fuel-operated heating device 5 can be operated for short time intervals in a particular efficient operation mode and can be maintained in a stopped state over long time intervals. This enables a particularly efficient operation of the fresh water heating system for mobile applications 1.

Alternatively, the coolant in the coolant reservoir 2 can be heated using the electric heating device 7. This can e.g. be controlled dependent on user input or dependent on availability of a mains power supply or based on another scheme.

If heating of air via the coolant-to-air heat exchanger 6 is desired, the coolant pump of the fuel-operated heating device 5 is operated to circulate the coolant in the coolant circuit 10 through the coolant-to-air heat exchanger 6 (and possibly a blower for the coolant-to-air heat exchanger 6 is operated). If the temperature of the coolant stored in the coolant reservoir 2 is high enough or if the coolant is heated using the electric heating device 7, only the coolant pump of the fuel-operated heating device 5 is operated without operating the fuel-operated heating device 5 to produce heat.

If warm or hot fresh water is needed, a user can e.g. select the appropriate temperature (e.g. a predetermined temperature for showering or for drink preparation) and the mixer valve 14 provides fresh water having the desired temperature. Fresh water is supplied to the liquid-to-liquid heat exchanger 9 and heated by heat transfer from the hot coolant contained in the coolant reservoir 2. In this way, fresh water is heated in the manner of a flow-type calorifier. The thus-heated fresh water is mixed with cold fresh water by the mixer valve 14 such that the desired temperature is provided.

According to one realization, the control unit 100 is adapted to control the operation of the fresh water heating system for mobile applications 1 in the manner which will be described in the following. The coolant in the coolant reservoir 2 is brought to a high temperature by means of the fuel-operated heating device 5. If a mains power supply is available at this stage, the electric heating element 7 can additionally be used for heating the coolant in the coolant reservoir 2. When the coolant has reached a desired upper temperature level, heat-producing operation of the fuel-operated heating device 5 is stopped and only the coolant pump is operated for circulating the coolant in the coolant circuit. If the heat demand (e.g. of the coolant-to-air heat exchanger 6 or for producing hot fresh water) is less than the electric heating device 7 is capable of producing and a mains power supply is available, then the heat is only produced by using the electric heating device 7 (and the fuel-operated heating device 5 is maintained in an idle state). However, if the heat demand is greater such that the temperature in the coolant reservoir 2 falls below a predetermined lower temperature level, operation of the fuel-operated heating device 5 for heat production is resumed. This realization allows a particularly efficient use of the energy sources electric energy and fuel. Further, a high heating power can be fast and efficiently provided by the fuel-operated heating device 5 and the electric heating device 7 can be realized with limited power. This enables a particular cost-efficient construction.

Thus, a “stand-alone” system for fresh water heating has been described which is independent from a coolant circuit of a combustion engine of a vehicle. This independent construction enables a particularly compact design of the system and makes the system easy to install, since only the supply line 11 and the warm water output line 16 have to be connected to a fresh water reservoir 12 and to at least one user, respectively. In particular in such a system, the coolant reservoir 2 can act as a header tank for the coolant circuit 10 realized as a closed heat transfer circuit such that no additional separate header tank is required. The described fresh water heating system for mobile applications 1 allows both heating of an internal space via the coolant-to-air heat exchanger 6 and of fresh water via the liquid-to-liquid heat exchanger 9. Since the coolant stored in the coolant reservoir 2 can be heated using the fuel-operated heating device 5, the heat can be produced and stored even when no mains power supply is available (e.g. during driving in a motor home application). Thus, e.g. in a motor home or caravan application, hot fresh water is available immediately after arrival at a destination. Further, the heat can be stored over longer time intervals in the coolant reservoir 2 without the risk of deteriorating the quality of a large quantity of fresh water. In comparison to fresh water heating systems for mobile applications in which a fresh water reservoir is provided and the fresh water in the fresh water reservoir is heated by coolant flowing through a liquid-to-liquid heat exchanger in the fresh water reservoir, the realization described above allows a substantially more efficient operation of the fuel-operated heating device 5.

According to a modification of the above described fresh water heating system for mobile applications 1, a coolant circuit of a combustion engine of a vehicle can be integrated into the coolant circuit 10. This can e.g. be realized by using the coolant circuit of the combustion engine as the coolant circuit 10 of the fresh water heating system 1. Alternatively, it is also possible to provide a number of valves such that the engine coolant circuit and the coolant circuit of the fresh water heating system 1 can be connected to each other and separated from each other by actuation of the valves. This connection can e.g. be realized in a manner as described in U.S. 2008/0142609 A1.

### SECOND EMBODIMENT

A second embodiment differs from the above described first embodiment in that the fuel-operated heat source is formed by a combustion engine 5′ of a vehicle. Thus, according to the second embodiment the fuel-operated heating device 5 is replaced by a combustion engine 5′. In this case, the waste heat of the combustion engine 5′ is used for heating the coolant in the coolant reservoir 2. Since the further features of the second embodiment do not differ from the first embodiment, a more detailed description is omitted.

Although it has been described with reference to the embodiments that the fresh water heating system for mobile applications 1 is adapted to be used in a recreational vehicle, other mobile applications are also possible. For example, the fresh water heating system for mobile applications 1 can be adapted for use in welfare cabins or the like. Also in this case, the system can be adapted for heating an interior and for heating fresh water.

1. Fresh water heating system for mobile applications comprising:
a coolant reservoir for storing a predetermined amount of coolant, the coolant reservoir comprising a coolant inlet for supplying coolant to the coolant reservoir and a coolant outlet for discharging coolant from the coolant reservoir;
a coolant circuit connected to the coolant inlet and the coolant outlet, the coolant circuit comprising a fuel-operated heat source; and
a liquid-to-liquid heat exchanger arranged in the coolant reservoir for transferring heat from stored coolant to fresh water.

2. Fresh water heating system according to claim 1, wherein an electric heating device for electrically heating the coolant contained in the coolant reservoir is provided.

3. Fresh water heating system according to claim 1, wherein the liquid-to-liquid heat exchanger is formed by a wound pipe section for fresh water to be heated arranged in the coolant reservoir.

4. Fresh water heating system according to claim 1, wherein a mixer valve is provided which is adapted to automatically mix fresh water heated in the liquid-to-liquid heat exchanger with cold fresh water to provide fresh water having a predetermined temperature.

5. Fresh water heating system according to claim 4, wherein the mixer valve is adapted to automatically provide one of at least two predetermined temperatures of the provided fresh water upon user selection.

6. Fresh water heating system according to claim 1, wherein the coolant reservoir is adapted as a header reservoir for compensating volume changes in the coolant circuit.

7. Fresh water heating system according to claim 1, wherein the fuel-operated heat source is formed by a fuel-operated heating device.

8. Fresh water heating system according to claim 1, wherein the fuel-operated heating device is an auxiliary vehicle heater.

9. Fresh water heating system according to claim 1, wherein the coolant circuit is a vehicle engine independent coolant circuit.

10. Fresh water heating system according to claim 1, wherein a combustion engine of a motor vehicle is integrated into the coolant circuit as a fuel-operated heat source.

11. Fresh water heating system according to claim 1, wherein the coolant circuit comprises a coolant-to-air heat exchanger for transferring heat from coolant to air for heating an internal space.
